(19) United States
(12) Patent Application Publication
(10) Pub. No.: US 2013/0218972 A1
(43) Pub. Date: Aug. 22, 2013

(54) LINKING USERS IN A NETWORK WITH COMPATIBLE DESIRED SOCIAL ACTIVITIES

(71) Applicant: Vinayak S. Joshi, Mountain View, CA (US)

(72) Inventor: Vinayak S. Joshi, Mountain View, CA (US)

(21) Appl. No.: 13/769,177

(22) Filed: Feb. 15, 2013

Related U.S. Application Data
(60) Provisional application No. 61/599,589, filed on Feb. 16, 2012.

(51) Int. Cl. H04L 29/08

(52) U.S. Cl. CPC H04L 67/22
USPC 709/204

(57) ABSTRACT

A technique for linking users in a network based upon compatible desired social activities. In a specific implementation the technique includes receiving a first set of desired social activities from a first user in a network towards a second user in a network and a second set of desired social activity from the second user towards the first user. The desired social activities can be compared to determine whether or not they are compatible. The first user and the second user can be linked if their desired social activities towards each other are compatible.

### REFERENCE TO EARLIER-FILED APPLICATION

This application claims priority to U.S. Provisional Patent Application Ser. No. 61/599,589, filed Feb. 16, 2012, entitled “Matching Social Intentions in a Network.”

### BACKGROUND

Social networks have continued to develop and grow in popularity. As social networks have continued to evolve the types of information that are available to those linked in social networks and the activities that can be performed while interacting with the social network have also continued to become more complex.

Social networks have also increased the ease by which people can become acquaintances. In particular people now use premium online dating services to make friends and meet potential partners. Typical online dating services can be expensive to users as they are built upon their own social networks. Specifically, typical online dating services are expensive as they are built upon the online dating service's own networking site system without the use of an already existing service supported on a different networking site system. Additionally, typical online dating services do not allow for the users to be linked based upon the desired social activities that users have towards each other and the types of activity that users would like to engage in together.

The foregoing examples of the related art are intended to be illustrative and not exclusive. Other limitations of the relevant art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not necessarily limiting in scope. In various embodiments, one or more of the above-described problems have been addressed, while other embodiments are directed to other improvements.

A technique for linking users in a network based upon compatible desired social activities towards each other. The technique can include presenting information about a first user to a second user and information about a second user to a first user. The first and second users can be in the same network, such as a social network. The information that is presented can include text identifying the users or pictures of the users. The information that is presented can be obtained from the network that the first user and second user share. The technique can include receiving a first set of desired social activities from a first user. The first set of desired social activities can include desired social activities that the first user has towards a second user. A second set of desired social activities are received from a second user. The second set of desired social activities can include desired social activities that the second user has towards a first user. The first set of desired social activities and second set of desired social activities can be compared to determine whether or not the first and second users have compatible desired social activities. Compatible can be defined as when the first set of desired social activities and the second set of desired social activities have at least one desired social activity in common. Compatible can also be defined as when at least one desired social activity in the first set of desired social activities is related to the second set of desired social activities. If compatible desired social activities are found, then the first user and the second user can be linked Linking can include matching the first user with the second user Linking can also include informing the first and second users that compatible desired social activities exist between them.

In a specific implementation, the second user is not informed that the first set of desired social activities of the first user toward the second user have been received. In another specific implementation, the second user is informed that desired social activities towards the second user have been received. In one implementation, the second user is informed what the desired social activities towards them are. In another implementation, the second user is informed of the identity of the user who has input desired social activities towards the second user. In another implementation, the second user is informed of the user who has input desired social activities towards the second user and is also informed as to what the input desired social activities towards the second user are.

These and other advantages will become apparent to those skilled in the relevant art upon a reading of the following descriptions and a study of the several examples of the drawings.

### BRIEF DESCRIPTION OF THE DRAWINGS

FIG. 1 depicts an example of an example of a system that is capable of linking users with compatible desired social activities.

FIG. 2 depicts a diagram of an example of a system for linking users based upon their desired social activities.

FIG. 3 depicts an example of a user interfaces of an application that is configured to link people based on compatible desired social activities.

FIG. 4 depicts a diagram of an example system for linking user based upon compatible desired social activities that includes pricing and payment subsystems.

FIG. 5 depicts a flowchart of an example of a method for linking users with compatible desired social activities.

FIG. 6 depicts a flowchart of an example of another method for linking users with compatible desired social activities.

### DETAILED DESCRIPTION OF THE INVENTION

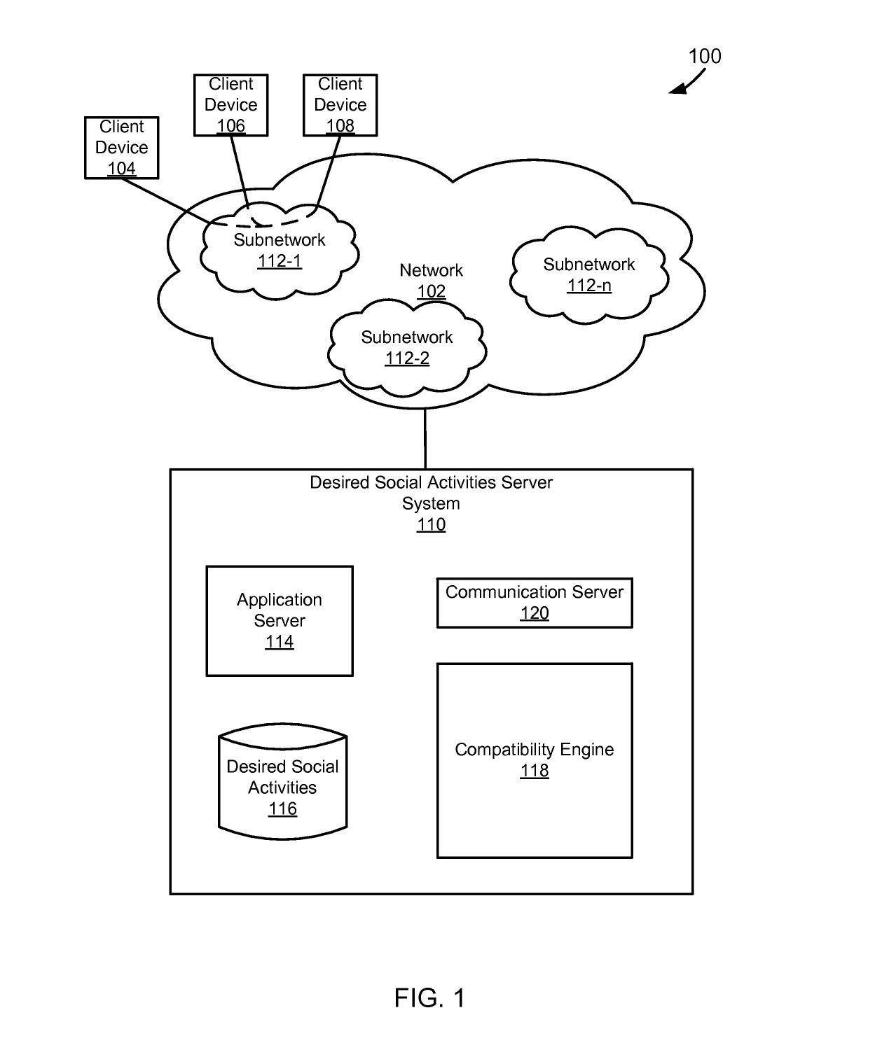

FIG. 1 depicts a diagram of an example of a system 100 that is capable of linking users with compatible desired social activities. For the purposes of this paper, linking can include matching a first user and a second user when their desired social activities towards each other are compatible Linking can also include informing the first user and the second user that they have compatible desired social activities. The system 100 includes a network 102, client devices 104, 106, 108 on the network, a desired social activities server system 110, and subnetworks 112-1 to 112-n (collectively, the subnetworks 112). The desired social activities server system 110 includes an application server 114, a desired social activities datastore 116, a compatibility engine 118, and a communications server 120.

In the example of FIG. 1, the network 102 can include several computer systems coupled together through the network 102. The network 102 may include a local area network (LAN) or a much larger network, such as the Internet. The term “Internet” as used herein refers to a network of networks which uses certain protocols. Such protocols can be the TCP/IP protocol, and possibly other protocols, such as the hypertext transfer protocol (HTTP) for hypertext markup language (HTML) documents that make up the World Wide Web (the web).

In the example of FIG. 1, the client devices 104, 106, 108 are coupled to the network 102. Each of the client devices 104, 106, 108 can be associated with a user. The client devices 104, 106, 108 can include or be included in computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer interfaces to external systems through the communications interface. To the extent that the client devices 104, 106, 108 are computer systems, they can, with the appropriate web browsing software, view HTML pages provided by a web server. An Internet service provider (ISP) provides Internet connectivity to the client computer system through the communications interface, which can be considered part of the client computer system. A computer system can also be set up and connected to the Internet without an ISP. The communications interface can include an analog modem, ISDN modem, cable modem, token ring interface, satellite transmission interface (e.g. “direct PC”), a network interface, or other interface for coupling a computer system to other computer systems. The client devices 104, 106, 108 can also be connected to the network 102 through a LAN, private network, or some other applicable subnetwork.

The subnetworks 112 can include social, professional, or self-generated networks like Facebook®, LinkedIn®, Myspace®, or some other applicable network. Millions of people are connected to social networks via various kinds of devices like desktop computer laptops or smart phones etc. Within this broad network, members connect with others with whom they have some kind of relationship, such as friends and acquaintances. Networks can include enterprise private networks and virtual private networks (collectively, private networks). As the name suggests, private networks are under the control of an entity rather than being open to the public. Private networks include a head office and optional regional offices (collectively, offices). Many offices enable remote users to connect to the private network offices via some other network, such as the Internet.

Depending on the context, a social network can have different meanings In the case of one of the subnetworks 112, the “social network” can be considered the entities who are members (e.g., Facebook® members), a private network (e.g., the hardware and software of Facebook®), or some combination of that which makes up the network. In the case of a first entity's social network, the “social network” can be considered data about other entities that is known to the first entity, through one or more of the subnetworks 112 and/or data that is stored in an address book or other datastore. The first entity's social network can alternatively be characterized as including one or more of the subnetworks 112, but in this paper such a characterization will be explicit (e.g., “a first entity's social network, including a subnetwork”).

In the example of FIG. 1, the desired social activities server system 110 includes the application server 114, the desired social activities database 116, and the compatibility engine 118. As used in this paper, an engine includes a processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

Optionally, the desired social activities server system 110 can be part of an ISP which provides access to the Internet for client systems. The application server 114 can, for example, be implemented as a web server. A web server typically includes or is implemented on at least one computer system which operates as a server computer system and is configured to operate with the protocols of the world wide web and is coupled to the Internet. A web server is normally coupled to web content, which can be considered a form of a media database.

The desired social activities datastore 116 can be implemented as a database, a flat file, or some other applicable storage format. The desired social activities datastore 116 can include user data associated with one of the subnetworks 112. Among the data, desired social activities of one entity for another entity can be stored, which is used by the compatibility engine 118.

The desired social activities server system 110 can receive desired social activities from the first user toward the second user in the first social network and from the second user towards the first user in the first social network through the application server 114. The desired social activities are stored in the desired social activities datastore 116. The stored desired social activities can be used to generate a likeability score, as is discussed later, for a certain user. The compatibility engine 118 uses the desired social activities of a first user toward a second user and the desired social activities of the second user toward the first user to link the first user and the second user. Each of the first and second users are associated with or use one of the client devices 104, 106, 108. The first user can be characterized as having a first social network of entities. The first social network can include a set of subnetworks of the subnetworks 112. Alternatively, the first social network can instead or in addition include entities with which a connection is not via a subnetwork (e.g., the entities could be associated with the first user's address book entries). The entities could also be from some degree of separation from the first user. For example, the first user can be given the ability to set desired social activities for people within both their own social network and the social network of a friend. This can extend the reach of an entity to “friends of friends,” which may be considered a meaningful degree of separation in some implementations.

In one implementation, the compatibility engine 118 can wait until the desired social activities of the second user toward the first user are known before linking the first user and the second user. In this way, the first user can avoid letting the second user know of any desired social activities toward the second entity. In an alternative implementation, the compatibility engine 118 can link the first user and the second user after the desired social activities of only the first user to the second user are known. In this way, the second user knows the desired social activities of the first user before the second user decides their desired social activities toward the first user.

When the compatibility engine 118 links the first and second user based on their desired social activities, the communication server 120 can send an alert to each of the first and second entities that they have compatible desired social activities. Alternatively, if the compatibility engine 118 does not link the first and second user because of differing desired social activities, the communication server 120 can send an alert to either one or both of the first and second users that they were not linked due to differing desired social activities. Alternatively the communication server 120 can send an alert to the second user after the desired social activities server system has received desired social activities from the first user regarding the second user.

In the example of FIG. 1, in operation, users that are associated with or use the client devices 104, 106, 108 and the desired social activities server system 110 are depicted as connected to the subnetwork 112-1. This is intended to illustrate that the client devices 104, 106, 108 are associated with users that are somehow affiliated with a specific subnetwork (e.g., the users have a social networking site account). In the example of FIG. 1, the client devices 104, 106, 108 are shown as connected through the subnetwork 112-1 with a dotted line. The dotted line is intended to illustrate that the client devices 104, 106, 108 are associated with users that are explicitly linked together within a specific subnetwork (e.g., the entities are “friends”). Advantageously, the desired social activities server system 110 can selectively link users who are actually friends within the specific subnetwork (or a given social network in which there is an explicit connection).

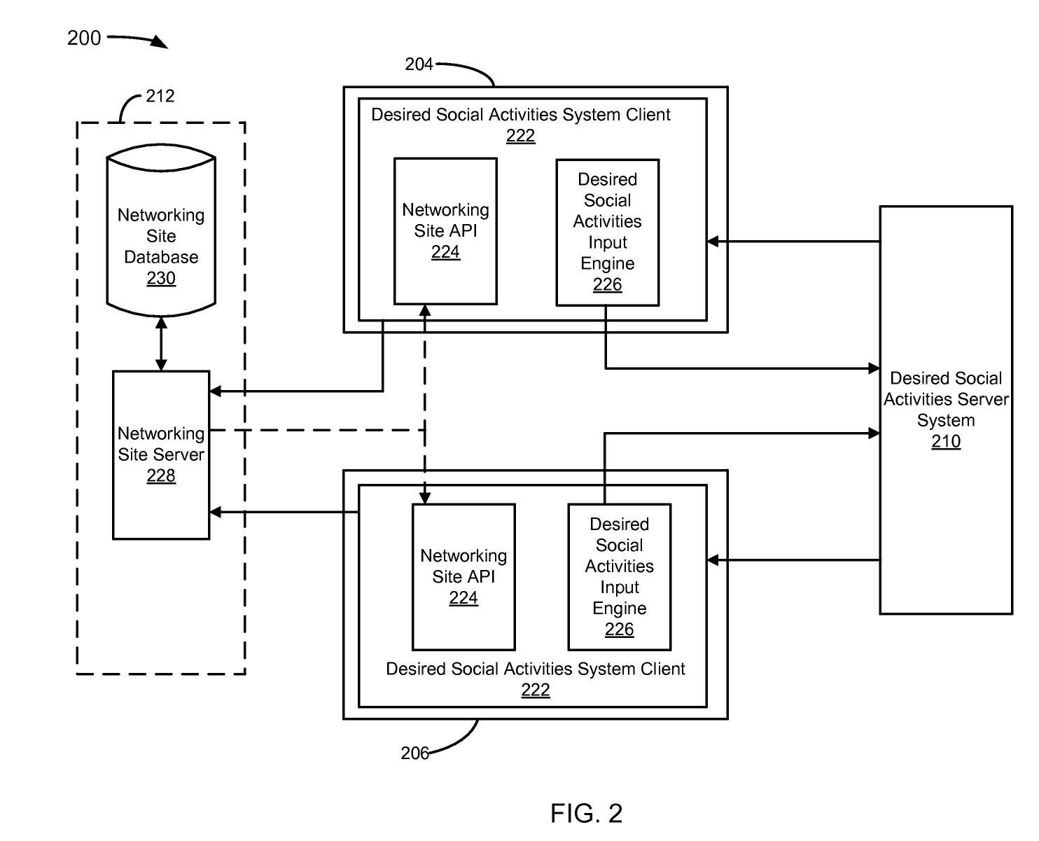

FIG. 2 depicts a diagram of an example of a system 200 for linking users based upon their desired social activities. The system 200 includes a client device 204, a client device 206, a desired social activities server system 210 and a networking site system 212. The networking site system 212 can support one of the previously mentioned subnetworks, such as a social network. For the purpose of this example, users that either use or are associated with client devices 204 and 206 are assumed to have accounts on the networking site system 212. The client devices 204 and 206 include a desired social activities system client 222. The desired social activities system client includes a networking site system API 224 and a desired social activities input engine 226. The networking site system 212 includes a networking site server 228 and a networking site datastore 230.

The client device 204 can use the networking site system API 224 to optionally receive data from the networking site datastore 230 through the networking site server 228. The data can be associated with a subset of other users of the networking site. The subset of other users can be grouped into the subset based upon the degree of separation from a user (e.g., friends of the user of the client device 204 and friends of a friend of the user of the client device 204). The data can include, for example, a user name, profile, picture, friends list or the like. The download of information is illustrated in the example of FIG. 2 as a dashed line with arrows. The client device 206 can optionally receive data in a similar manner.

The desired social activities input engine 226 can render identifications of users of a social network to the user who uses or is associated with the client device 204. For the purposes of this example the users whose identifications are rendered can include the subset of users of the networking site, and selectable desired social activities identifications. A user of the device 204 can select appropriate desired social activities for one or more of the users of the social network within the subset that are rendered to the user. Thus, a first user can select desired social activities toward a second user. The desired social activities input engine 226 can send the first user's desired social activities toward the second user to the desired social activities server system 210.

The desire to maintain secrecy regarding one users desired social activities towards a second user can lead to a heightened desire to protect secrecy in a particular implementation. For example, it may be desirable to keep information that is provided to the desired social activities server system to a minimum. In one implementation, the data that is sent to the desired social activities server system 210 is encrypted. Depending upon the implementation, the users of the service can be given different levels of anonymity (e.g., user A might be able to express a desired social activity toward user B as a secret admirer, user A might be able to express a desired social activity for user B without user B becoming aware that anyone expressed the desired social activity unless user B expresses the same desired social activity toward user A, user B might become aware of a desired social activity being expressed toward them without knowing the desired social activity was expressed by user A unless user B expresses the same desired social activity back to user A, user B might become aware that user A expressed a desired social activity toward them without knowing the specific desired social activity unless user B expresses the same desired social activity toward user A, a hint can be sent to user B that user A checked them out without indicating whether user A expressed a desired social activity, the popularity of user A could be hidden, the popularity of user A could be hidden until a match is made with user B, the popularity of user A could be hidden until a desired social activity is expressed, the popularity of user A could be available to a subset of their network, etc.). Although the users are generally part of one another's or a friend's network, it may be desirable to keep some information private, such as contact information. The amount of privacy afforded various individuals can be dependent upon the implementation, configurations, and user preferences, if applicable.

The desired social activities server system 210 receives the data from the device 204 and stores the data in a datastore. In accordance with the above mentioned implementation, the data can be encrypted. In a specific example, the data includes a first user identifier, a second user identifier, and a desired social activities identifier. One way of keeping the data secure is to ensure that the first user is identified using a hash created at the client device 204 based on a number of values (e.g., name, address, phone number, or the like). That way, the desired social activities server system 210 only has a hash value, as opposed to potentially sensitive personal information. The second user can also be associated with a hash created at the client device 204. Ideally, the hashes can be generated at any client device that has the appropriate information about a user, the hashes will be the same regardless of the device on which they are generated, and the hashes will be unique. The desired social activities identifier can be hashed in a similar manner, or simply represented as a numerical value that is largely meaningless when taken out of context. A user of the client device 204 and 206 can provide desired social activities of the second user toward the first user in a similar manner to that described above.

The compatibility engine at the desired social activities server system 210 can compare the desired social activities that were previously stored in the desired social activities dat store (toward the second user by the first user) with the desired social activities of the second user toward the first user. If the compatibility engine determines that the users desired social activities are compatible, the desired social activities server system 210 informs the desired social activities system users that are associated with or use the client devices 204 and 206.

In one implementation, the compatibility engine can determine that users have compatible desired social activities if the input desired social activities have at least one desired social activity in common. In another implementation, the input desired social activities of the first and second users towards each other do not need to be identical but can instead be merely related in order for the compatibility engine to determine that the users desired social activities are compatible. Desired social activities can be related if they involve a similar type of activity. For example, if a first user is interested in going out on a date and the second user is interested in going out to lunch, the compatibility engine could indicated to the first and second user that there are shared interests in going out to lunch even though the input desired social activities are not identical. Advantageously, if there is no compatibility, then nobody knows anything about the desired social activities except the entity who expressed them. This avoids feelings of rejection or possible damage to existing relationships if desired social activities are not compatible.

Depending upon the implementation, information maintained at the desired social activities server system 210 is deleted after a certain period of time (e.g., 3 months). If the compatibility engine determines that two users have compatible desired social activities, the desired social activities server system 210 may or may not maintain the data longer to enable entities to change their desired social activities as they get to know one another.

Depending upon the implementation and/or configuration, the desired social activities system client 222 can update the networking site server 228 with an alert that users have been matched because of compatible desired social activities. Thus, a user of the networking site can be informed that there is compatibility with someone, prompting the user to check. It is also possible to send compatibility results via email or other contact medium.

The following is a list of examples of desired social activities:

1. Coffee date

2. Lunch date

3. Dinner date

4. Drink date

5. Activity date (e.g., movie, walking, running, hiking, cooking, outing, visiting museum, etc.)

6. Let's hook up

7. You are cool!

8. Want to be friends

9. Want to be more than acquaintances

10. Steady relationship

11. Committed (but not marriage) relationship

12. Marriage

13. No Strings Attached/relationship

14. Friends with Benefits relationship

15. I want to break up

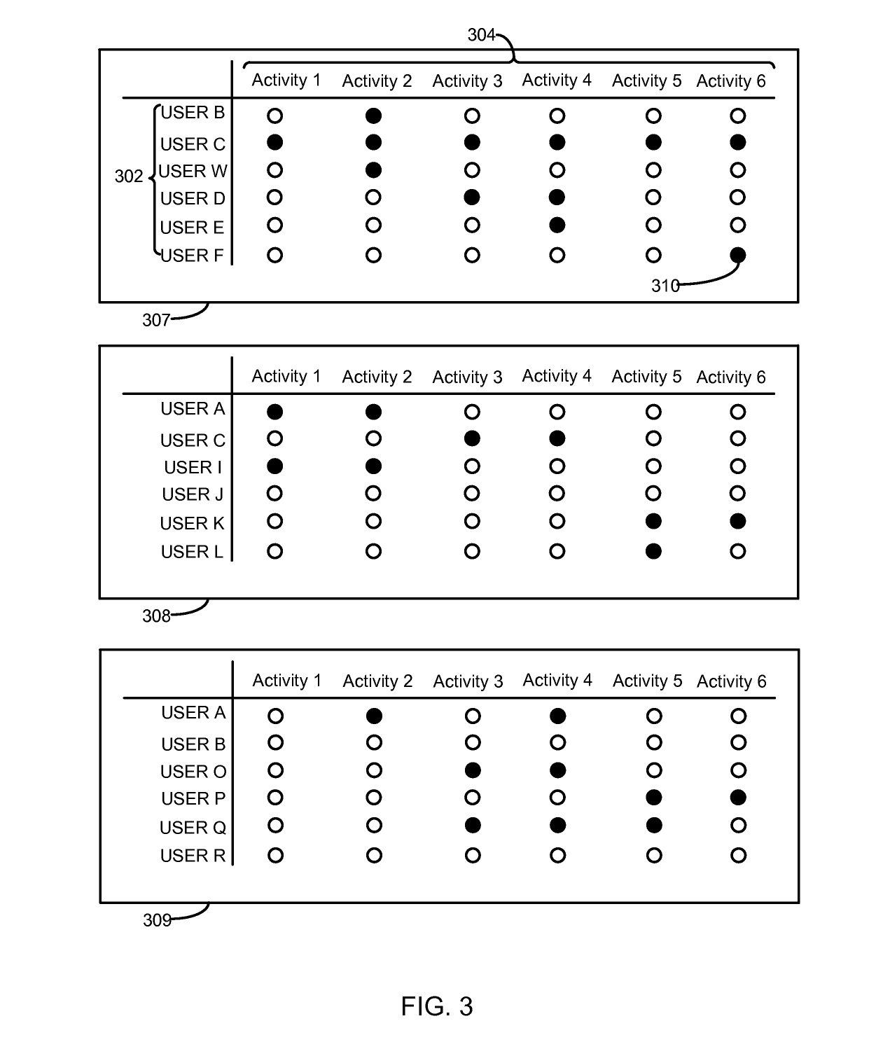

FIG. 3 depicts an example of user interfaces of an application that is configured to link people based on compatible desired social activities. The three shown user interfaces are the interfaces for three different users that are presented through client devices. For example, interface 307 is the interface for user A, interface 308 is the interface for user B and interface 309 is the interface for user C. Each interface includes a list of related users 302 that have a certain degree of separation from the user in a specific network, such as a social network. For example, the related users can be the friends of the friends of a user. The related users can be presented in the list of related users 302 by displaying data that is unique to each related user, such as the specific name of the user or a picture of the user. The data of the related users is retrieved by the application through the specific network API.

The user interface also includes a list of different desired social activities 304. The different desired social activities can be displayed numbers with explanations, or described directly as text. In the shown example, there are six desired social activities that a user can select for each related user. In other implementations a user can be presented with more or less desired social activities.

The list of desired social activities 304 and the list of related users 302 can form a table of data fields. Each data field 310 can represent a specific desired social activity for one of the related users. A user can populate each data field based upon whether or not they have the specific desired social activity for the user that corresponds to the data field. In the shown example, each data field is represented by a radio button 310. However, desired social activities can be represented in other ways. For example, a desired social activity can be expressed numerically as the number of hours a user wants to spend with another user per week. Alternatively, a desired social activity can be expressed based upon how much a user likes another user (e.g., on a scale of 1 to 5), or in some other applicable manner. The linking can then be based on the highest numerical value of each user. Alternatively, desired social activities can be described through text and the linking can be text-based. For example, if a first user indicates an interest in “going out to dinner” with a second user and the second user indicates an interest in “having lunch” with the first user, a text-based analysis could determine that there are compatible desired social activities between the first and second users. Additionally, the text-based desired social activity for a first user can be a catch-all “I want to do anything” a second user wants to do. As a result, if the second user expresses any desired social activity towards the first user, then the users have compatible desired social activities and can be linked.

In populating the data fields with information in the example interfaces shown in FIG. 3, a user selects the radio button to signify a desired social activity with the specific user. For the purposes of illustration, the selected radio buttons are shown in the user interfaces 307, 308, 309 as filled in circles, while the unselected radio buttons are shown as empty circles. The information that is entered into the data fields is stored and then used to determine whether or not users have compatible desired social activities.

In the example of FIG. 3, as is shown by the interface for user A 307 and the interface for user B 308, both users A and B have desired social activity 2 towards each other. Additionally, while user B has desired social activity 1 towards user A, user A does not have desired social activity 1 towards user B. As a result, users A and B can be linked based upon the shared desired social activity 2 that the users have towards each other.

In the example of FIG. 3, as is shown by the interface for user C 309, user C has desired social activities 2 and 4 for user A and no desired social activities for user B. As is shown by the interface for user A 307, user A has selected all of the available desired social activities for user C. Therefore, users A and C have desired social activities 2 and 4 towards each other and can be linked based upon such compatible desired social activities. As is shown by the interface for user B 308, user B has desired social activities 3 and 4 towards user C. However, as user C does not have any desired social activities towards user B, they do not have compatible desired social activities. As a result, users B and C are not linked together.

In an alternative implementation, the user interface can display a likeability score for each user in the list of users 302. The likeability score can be a numerical value or another form of text. The score can be based on the desired social activities that other users have expressed towards a certain user. Specifically, the likeability score can be the number of desired social activities that various users have set for a certain user or the number of users that have input a desired social activity about a specific user. For example, user A can have a likeability score of ‘0’ if no other users express desired social activities, or a likeability score equal to the number of other users who express desired social activities for user A. Alternatively, the likeability score can be based on the type of desired social activities that various users have set for a certain user. The likeability score can be adjusted using a function that degrades the score over time. The likeability score can be used to find popular people and can be displayed in any of the interfaces that are presented to a user when the user is interacting with the previously described systems. Specifically, the likeability score is not limited to being displayed only in the interfaces shown in FIG. 3.

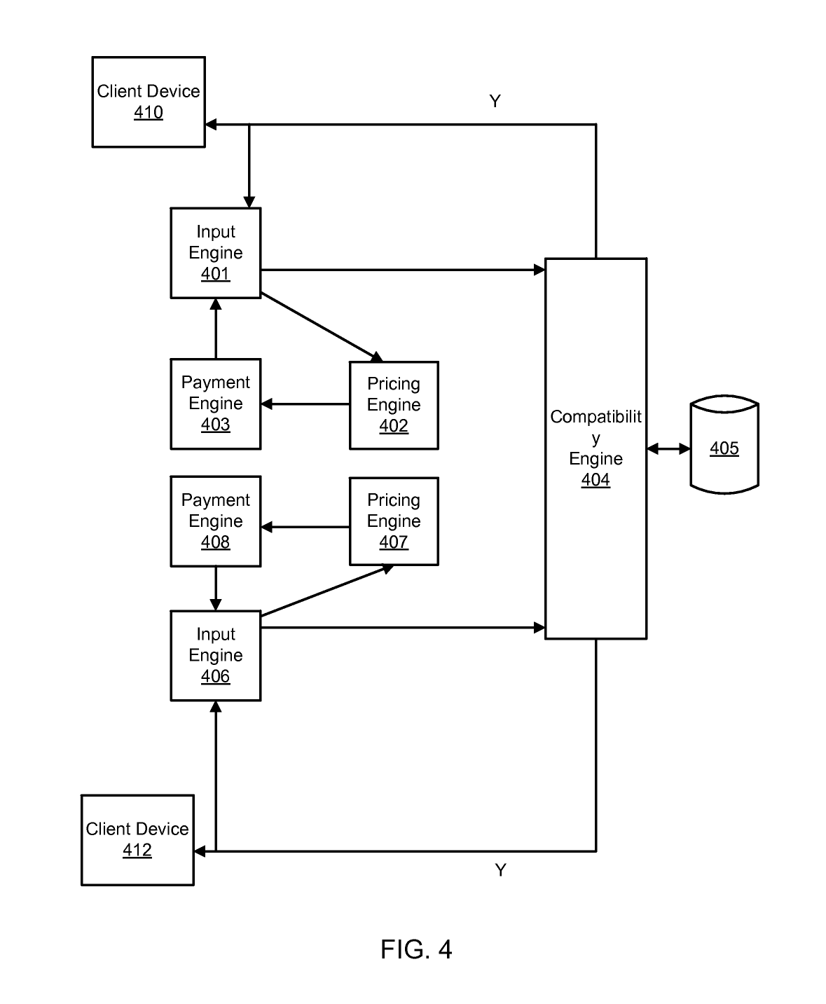

FIG. 4 depicts a diagram of an example system for linking user based upon compatible desired social activities that includes pricing and payment subsystem. The system includes client devices 410 and 412, input engines 401 and 405, payment engines 403 and 408, pricing engines 402 and 407, a compatibility engine 404 and a datastore 405. A first user is associated with and uses the client device 410 while a second user uses the client device 412. The users provide their desired social activities for various users through the input engines 401 and 405.

Pricing engines 402 and 407 are coupled to the input engine to determine a price to charge the user. The price can be based on the number of desired social activities or the type of desired social activities that a user inputs into the input engines 401 and 405. Specifically in one pricing model, some of the available desired social activities that a user can select can be free, while others could cost a certain amount. Additionally, the selection of desired social activities could vary in price based upon the type of desired social activity that is selected. Another model for determining the price can be to enable a user to purchase a number of desired social activity selections that can be input (e.g., 10 selections for $10). In an alternative pricing model, an initial number of desired social activity selections could be made available for free. In another alternative pricing model, users can pay for selections as they are made or before they are processed. In yet another alternative pricing model, the price can be a subscription fee that allows a user an unlimited amount of selections during a given period of time. The subscription can take the form of a purchased application from an application store that is run on a client device. The previously listed pricing models can be combined in any way to form a specific pricing model for the system. Additionally the pricing model that is employed by the pricing engines 402 and 407 is not limited to any of the previously listed or any combinations of pricing models.

Payment engines 403 and 408 are coupled to both the input engine and the pricing engine. The payment engines 403 and 408 receive instructions on an amount of money to charge the users from the pricing engines 402 and 407. The payment engines 403 and 408 accepts payments made by a user through the input engines 401 and 405. The payment engine processes the payments in accordance with the applicable pricing model and determines whether or not the user has actually paid the correct amount. If the payment engines 403 and 408 determine that the user has paid the correct amount, it instructs the input engines 401 and 405 to send the desired social activities input by the users to the compatibility engine 404.

The compatibility engine 404 receives the desired social activities input from the users of the client devices 410 and 412. The compatibility engine 404 is coupled to a datastore 405. The compatibility engine stores the social engines in the datastore 405. The users input desired social activities can be maintained in an encrypted form in the database (405) for a predefined amount of time. The amount of time can depend on when corresponding desired social activities are received from another user.

After receiving desired social activities from two users regarding each other, the compatibility engine 404 checks whether the users have compatible desired social activities. If the compatibility engine 404 does find that compatible desired social activities exist between the two users, then it will notify the two users.

The systems described in this paper can be implemented as a standard application, desired social activities application, for any social network, like Facebook® or MySpace®. The user can download and install the application which will then be visible in the context of his or her social network application interface. When the user makes selections on the desired social activities application and saves their choices, the application can communicate those desired social activities to the desired social activities web application server which in-turn can communicate them with the datastore. All communication can be encrypted when it is transmitted over the network or when it is saved in the datastore.

If compatible desired social activities are found, the desired social activities web application server can send an email to both users indicating that compatible desired social activities was found between them. A coupon provisioning engine in the server (or at some other server) can provide relevant coupons to users when compatible desired social activities are found. For example, if user A and user B have a coffee match, the coupon provisioning engine can send a coffee coupon for two to the initiator, a coffee coupon for one to each of the users, or some other number of coffee coupons. The coupons can come from a partner of the entity in control of the desired social activities server. Coupons can also be made available for other types of matches, such as lunch matches (coupons for lunch), dinner matches (coupons for dinner), drinks matches (coupons for drinks), etc. Other coupons might also be provided to the initiator (e.g., coupons for flowers, etc.) or for the responder (e.g., background check services coupons) or for both of the matched users (coupons for flowers, background services coupons, etc.).

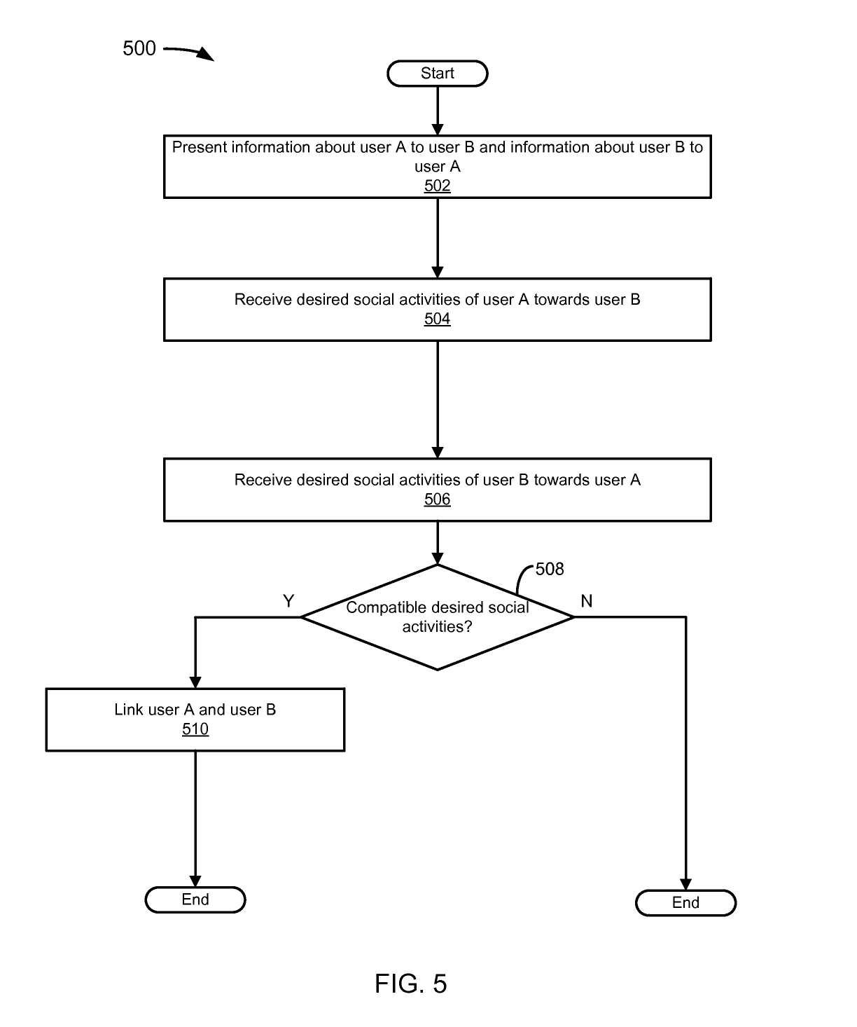

FIG. 5 depicts a flowchart 500 of an example of a method for linking users with compatible desired social activities. The example flowchart 500 in FIG. 5 can be implemented using any of the systems described in this paper. The flowchart 500 starts at module 502 with presenting information to user A about user B and information about user B to user A. Such information can be a picture or text describing each user. The information can be obtained through a network, such as a social network.

Next the flowchart 500 continues to module 504 with receiving desired social activities of user A towards user B. In one implementation, the flowchart continues to module 506 without informing user B that any desired social activities for them have been received. The flowchart 500 continues to module 506 with receiving desired social activities of user B towards user A. The flowchart 500 then continues to decision point 508 where it is determined whether or not compatible desired social activities exist between user A and user B. Desired social activities can be compatible, as previously described, when the users have at least one specified desired social activity in common or when the users have related desired social activities. If it is determined that the users have compatible desired social activities, then flowchart 500 continues to module 510 with linking users A and B, after which the flowchart ends Linking can include informing users A and B that compatible desired social activities exist between them. If, at decision point 508, it is determined that the users do not have compatible desired social activities, then the flowchart ends.

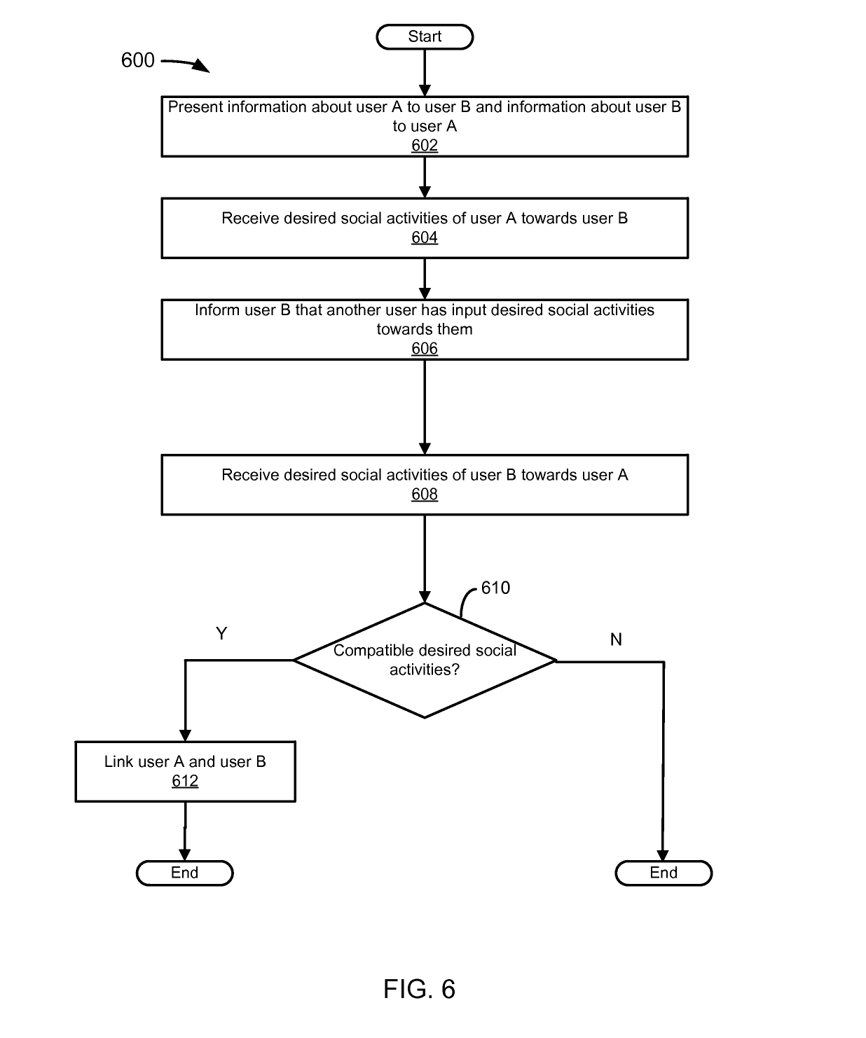

FIG. 6 depicts a flowchart 600 of an example of another method for linking users with compatible desired social activities. The example flowchart 600 in FIG. 6 can be implemented using any of the systems described in this paper. The flowchart 600 starts at module 602 with presenting information to user A about user B and information about user B to user A. Such information can be a picture or text describing each user. The information can be obtained through a social network.

The flowchart 600 continues to module 604 with receiving desired social activities of user A towards user B. Next the flowchart 600 continues to module 606 with informing user B that another user has input desired social activities towards them. In various implementations informing user B can include describing who has input desired social activities towards user B and what the input desired social activities are.

Then the flowchart continues to module 608 with receiving desired social activities of user B towards user A. The flowchart 600 then continues to decision point 610 where it is determined whether or not compatible desired social activities exist between user A and user B. Desired social activities can be compatible, as previously described, when the users have at least one specified desired social activity in common or when the users have related desired social activities. If it is determined that the users have compatible desired social activities, then flowchart 600 continues to module 612 with linking users A and B, after which the flowchart ends. Linking can include informing users A and B that compatible desired social activities exist between them. If at decision point 610, it is determined that the users do not have compatible desired social activities, then the flowchart ends.

While preferred implementation of the present inventive apparatus and method have been described, it is to be understood that the implementations described are illustrative only and that the scope of the implementations of the present inventive apparatus and method is to be defined solely by the appended claims when accorded a full range of equivalence, many variations and modifications naturally occurring to those of skill in the art from a perusal thereof.

What is claimed:

1. A method of linking users in a network based upon desired social activities comprising:
presenting first user information to a second user in a network and second user information to a first user in the network;
receiving a first set of desired social activities of the first user towards the second user and a second set of desired social activities of the second user towards the first user;
determining whether the first set of desired social activities are compatible with the second set of desired social activities;
linking the first user with the second user if the desired social activities are compatible.

2. The method of claim 1, further comprising informing the second user that the first set of desired social activities were received.

3. The method of claim 1, wherein linking the first user with the second user includes informing the first user and the second user that the first set of desired social activities are compatible with the second set of desired social activities.

4. The method of claim 1, wherein the first user information is obtained from the network and the second user information is obtained from the network.

5. The method of claim 1, wherein compatible is defined as when at least one desired social activity in the first set of desired social activities is the same as at least one desired social activity in the second set of desired social activities.

6. The method of claim 1, wherein compatible is defined as when at least one desired social activity in the first set of desired social activities is related to at least one desired social activity in the second set of desired social activities.

7. The method of claim 1, further comprising charging the first user a price.

8. The method of claim 7, wherein the price is based on either or both a number of desired social activities in the first set of desired social activities and types of desired social activities in the first set of desired social activities.

9. The method of claim 4, wherein the first user information and the second user information are obtained through an API of the network.

10. The method of claim 1, wherein the first set of desired social activities and second set of desired social activities is encrypted data.

11. A system for linking users in a network based upon desired social activities comprising:
a networking site server configured to present first user information to a second user in a network and second user information to a first user in the network;
an application server configured to receive a first set of desired social activities of the first user towards the second user and receive a second set of desired social activities of the second user towards the first user;
a compatibility engine configured to determine whether the first set of desired social activities are compatible with the second set of desired social activities and link the first user with the second user.

12. The system of claim 11, further comprising a communication server configured to inform the second user that the first set of desired social activities were received.

13. The system of claim 11, further comprising a communication server configured to inform the first user and the second user that the first set of desired social activities are compatible with the second set of desired social activity.

14. The system of claim 11, wherein compatible is defined as when at least one desired social activity in the first set of desired social activities is the same as at least one desired social activity in the second set of desired social activities.

15. The system of claim 11, wherein compatible is defined as when at least one desired social activity in the first set of desired social activities is related to at least one desired social activity in the second set of desired social activities.

16. The system of claim 11, further comprising a payment engine configured to charge the first user a price.

17. The system of claim 16, wherein the price is based on either or both a number of desired social activities in the first set of desired social activities and types of desired social activities in the first set of desired social activities.

18. A system for linking users in a network based upon desired social activities comprising:
means for presenting first user information to a second user in a network and second user information to a first user in the network;
means for receiving a first set of desired social activities of the first user towards the second user and receiving a second set of desired social activities of the second user towards the first user;
means for determining whether the first set of desired social activities are compatible with the second set of desired social activities;
means for linking the first user with the second user if the desired social activities are compatible.
